(19) United States
(12) Patent Application Publication
(10) Pub. No.: US 2015/0343843 A1
(43) Pub. Date: Dec. 3, 2015

(54) TIRE TREAD WITH INCOMPATIBLE RUBBERS

(71) Applicant: MICHELIN RECHERCHE ET TECHNIQUE S.A., Granges-Paccott (CH)

(72) Inventors: Anthony Derbin CATO, Greer, SC (US); Raymond STUBBLEFIELD, Greenville, SC (US); Xavier SAINTIGNY, Greer, SC (US); Olivier PIFFARD, Mauldin, SC (US)

(73) Assignee: Michelin Recherche et Technique S.A., Granges-Paccot (CH)

(21) Appl. No.: 14/655,776

(22) PCT Filed: Dec. 20, 2013
(86) PCT No.: PCT/US13/76895

§ 371 Date: Jun. 26, 2015

Related U.S. Application Data
(60) Provisional application No. 61/747,663, filed on Dec. 31, 2012.

(51) Int. Cl. B60C 1/00; C08L 9/06; B60C 11/00

(52) U.S. Cl. CPC B60C 1/0016; B60C 11/0008; C08L 9/06; C08L 2205/025

(57) ABSTRACT

A tread for a tire, the tread comprising a rubber composition that is based upon a cross-linkable elastomer composition, the cross-linkable elastomer composition comprising, per hundred parts by weight of rubber (phr), a high-Tg rubber being a highly unsaturated diene elastomer having a glass transition temperature of between −30° C. and 0° C., a low-Tg rubber being a highly unsaturated diene elastomer having a glass transition temperature of between −110° C. and −60° C. The high-Tg and the low-Tg elastomers are incompatible and this provides, among other advantages, improved snow traction of the tread when compared to tire treads having lower Tg.

### BACKGROUND OF THE INVENTION

1. Field of the Invention

This invention relates generally rubber compositions and more particularly, to rubber compositions for tire manufacture.

2. Description of the Related Art

Driving on snow covered roads and under icy conditions has always been a challenge for drivers. The roads are slippery and there is a need to provide tires that have enhanced traction capability under such driving conditions.

As is generally known, the tire tread is the road-contacting portion of a vehicle tire that extends circumferentially about the tire. It is designed to provide the handling characteristics required by the vehicle; e.g., traction, cornering and so forth—all being provided with a minimum amount of noise being generated and with low rolling resistance so that a favorable fuel economy may be obtained.

The tire industry seeks to find new materials and new tire constructions for treads that provide the enhanced handling characteristics desired by today's drivers. New constructions and materials are especially sought after in the field of snow tires and all-weather tires.

### BRIEF DESCRIPTION OF THE DRAWINGS

FIG. 1 is a graph showing the glass transition temperature of each of two elastomers and showing the two glass transition temperatures of the incompatible mixture.

### DETAILED DESCRIPTION OF PARTICULAR EMBODIMENTS

Particular embodiments of the present invention include treads for tires and the rubber compositions from which they may be manufactured. The rubber compositions disclosed herein are particularly useful, in some embodiments, for the manufacture of treads for snow tires and/or all weather tires that are designed for running in snow conditions.

It is known to those skilled in the art that lowering the glass transition temperature (Tg) of a rubber composition used to manufacture a tire tread will improve the snow traction of the tire. The inventors have discovered that a tire tread manufactured from a rubber composition that includes both a high-Tg rubber component and a low-Tg rubber component that are incompatible with each other when mixed together surprisingly provides a tire tread having improved snow traction over tire treads having a lower Tg.

The glass transition temperature of a rubber component or a rubber composition, in its broadest terms, is the temperature below which the rubber behaves more like a glassy and brittle material and above which the rubber behaves more like an elastomer. This transition typically occurs over a temperature range and the rubber Tg is given as the midpoint of this range. There are different methods for determining the glass transition temperature of a rubber or rubber composition. Differential scanning calorimetry (DCS) is a common method used to measure the glass transition temperature of a rubber and one such method is provided in ASTM D3418, Standard Test Method for Transition Temperatures and Enthalpies of Fusion and Crystallization of Polymers by Differential Scanning calorimetry.

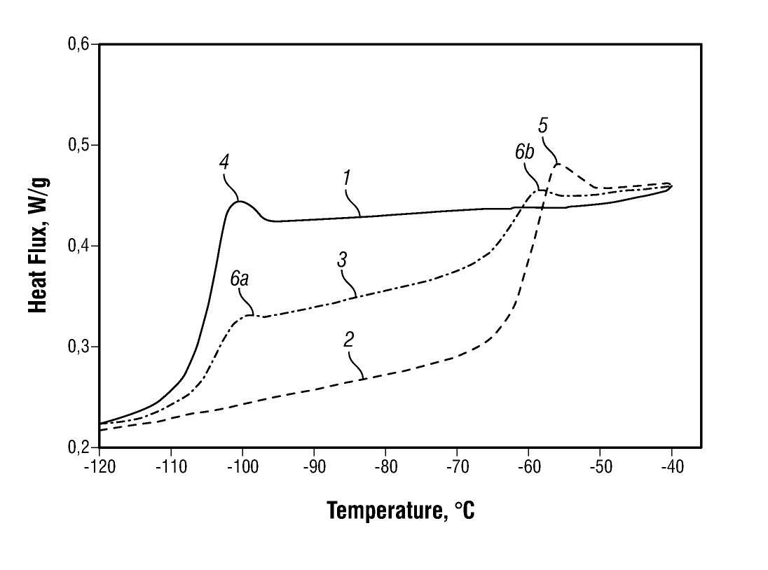

FIG. 1 is a graph showing the glass transition temperature of each of two elastomers and showing the two glass transition temperatures of the incompatible mixture. The traces shown in FIG. 1 are the output from a differential scanning calorimeter used in accordance with ASTM D3418 to determine the glass transition temperatures of a polybutadiene, a natural rubber and a 50:50 mix of the two. The output in watts per gram is plotted against the temperature of the sample being tested.

The polybutadiene trace 1 has a peak 4 around −100° C. that indicates the Tg of the polybutadiene. The natural rubber trace 2 has a peak 5 around −60° C. that indicates the Tg of the natural rubber is around −60° C. The mixture trace 3 that is a 50:50 mixture of the polybutadiene and the natural rubber has two peaks, the first peak 6a at around −100° C. and the second peak 6b at around −60° C. Since the mixture trace 3 has multiple peaks that show the individual rubber component peaks, these rubbers are incompatible. Had the mixture had only one peak, the two rubbers would have been compatible and typically, the one peak would have been somewhere between the individual elastomer glass transition temperatures.

Methods for successfully predicating whether rubbers will be compatible or incompatible are not known. Therefore, it is somewhat of a trial-and-error approach of selecting elastomers, blending them together and then determining through DSC in accordance with ASTM D3418 whether the elastomers are compatible or incompatible. A mixture of incompatible rubbers will have Tg peaks representing the individual peak of each of the rubbers in the incompatible blend so that each rubber component in the blend still indicates its presence through its Tg peak in the mix. A mixture of compatible rubbers, on the other hand, will have a Tg peak that is a blend of the peaks of the individual rubbers in the blend so that each component rubber no longer indicates its presence through its own Tg peak in the blend. Therefore, if mixture of different rubbers has but one Tg peak measured in accordance with ASTM D3418, then the rubber mixture is of compatible rubbers.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, elastomer and rubber are synonymous terms.

As used herein, “based upon” is a term recognizing that embodiments of the present invention are made of vulcanized or cured rubber compositions that were, at the time of their assembly, uncured. The cured rubber composition is therefore “based upon” the uncured rubber composition. In other words, the cross-linked rubber composition is based upon or comprises the constituents of the cross-linkable rubber composition.

Reference will now be made in detail to embodiments of the invention. Each example is provided by way of explanation of the invention. For example, features illustrated or described as part of one embodiment can be used with another embodiment to yield still a third embodiment. It is intended that the present invention include these and other modifications and variations.

As noted above, particular embodiments of the present invention include tire treads that are formed at least in part of a rubber composition that includes two incompatible diene elastomers, the first diene elastomer being a high-Tg rubber and the second diene elastomer being a low-Tg rubber.

Diene elastomers result at least in part, i.e., a homopolymer or a copolymer, from diene monomers, i.e., monomers having two double carbon-carbon bonds, whether conjugated or not. These diene elastomers may be classified as either “essentially unsaturated” diene elastomers or “essentially saturated” diene elastomers. As used herein, essentially unsaturated diene elastomers are diene elastomers resulting at least in part from conjugated diene monomers, the essentially unsaturated diene elastomers having a content of such members or units of diene origin (conjugated dienes) that is at least 15 mol. %. Within the category of essentially unsaturated diene elastomers are highly unsaturated diene elastomers, which are diene elastomers having a content of units of diene origin (conjugated diene) that is greater than 50 mol. %.

Those diene elastomers that do not fall into the definition of being essentially unsaturated are, therefore, the essentially saturated diene elastomers. Such elastomers include, for example, butyl rubbers and copolymers of dienes and of alpha-olefins of the EPDM type. These diene elastomers have low or very low content of units of diene origin (conjugated dienes), such content being less than 15 mol. %.

Examples of suitable conjugated dienes include, in particular, 1,3-butadiene, 2-methyl-1,3-butadiene, 2,3-di(C₁-C₅ alkyl)-1,3-butadienes such as, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Examples of vinyl-aromatic compounds include styrene, ortho-, meta- and para-methylstyrene, the commercial mixture “vinyltoluene”, para-tert-butylstyrene, methoxystyrenes, chloro-styrenes, vinylmesitylene, divinylbenzene and vinyl naphthalene.

The copolymers may contain between 99 wt. % and 20 wt. % of diene units and between 1 wt. % and 80 wt. % of vinyl-aromatic units. The elastomers may have any microstructure, which is a function of the polymerization conditions used, in particular of the presence or absence of a modifying and/or randomizing agent and the quantities of modifying and/or randomizing agent used. The elastomers may, for example, be block, random, sequential or micro-sequential elastomers, and may be prepared in dispersion or in solution; they may be coupled and/or starred or alternatively functionalized with a coupling and/or starring or functionalizing agent.

Examples of suitable diene elastomers useful in particular embodiments of the rubber compositions disclosed herein include highly unsaturated diene elastomers such as polybutadienes (BR), polyisoprenes (IR), natural rubber (NR), butadiene copolymers, isoprene copolymers and mixtures of these elastomers. Such copolymers include butadiene/styrene copolymers (SBR), isoprene/butadiene copolymers (BIR), isoprene/styrene copolymers (SIR) and isoprene/butadiene/styrene copolymers (SBIR).

Particular embodiments of the rubber compositions disclosed herein include a high-Tg rubber having a glass transition temperature of between −30° C. and 0° C. or alternatively between −20° C. and −5° C. The low-Tg rubber for such particular embodiments have a glass transition temperature of between −110° C. and −60° C. or alternatively between −100° C. and −80° C.

In some embodiments of the rubber compositions disclosed herein, the high-Tg rubber component may be selected from a synthetic polyisoprene rubber, an isoprene/styrene copolymer, a styrene/butadiene copolymer and in any combinations thereof as long as their glass transition temperatures fall within the range disclosed above. In addition to these rubbers, other suitable elastomers may include isoprene/butadiene copolymers and isoprene/butadiene/styrene copolymers either singly or in any combination thereof or in any combination with those rubbers listed above as being suitable for the high-Tg rubber component.

In some embodiments of the rubber compositions disclosed herein, the low-Tg rubber component may be selected from a polybutadiene, a synthetic polyisoprene rubber, an isoprene/styrene copolymer, a styrene/butadiene copolymer, a natural rubber and in any combinations thereof as long as their glass transition temperatures fall within the range disclosed above. In addition to these rubbers, other suitable elastomers may include isoprene/butadiene copolymers and isoprene/butadiene/styrene copolymers either singly or in any combination thereof or in any combination with those rubbers listed above as being suitable for the low-Tg rubber component.

In particular embodiments of the rubber compositions disclosed herein the rubber composition may include between 55 phr and 90 phr of the low-Tg rubber or alternatively between 60 phr and 90 phr, between 60 phr and 80 phr, between 65 phr and 90 phr or between 65 phr and 80 phr of the low-Tg rubber component. In particular embodiments, the rubber composition may include between 10 phr and 45 phr of the high-Tg rubber or alternatively, between 10 phr and 45 phr, between 20 phr and 40 phr, between 10 phr and 35 phr or between 20 phr and 35 phr of the high-Tg rubber.

In addition to the incompatible rubbers, particular embodiments of the rubber compositions disclosed herein may further include a reinforcing filler. Reinforcing fillers are added to rubber compositions to, inter alia, improve their tensile strength and wear resistance. Any suitable reinforcing filler may be used in the compositions disclosed herein including, for example, carbon blacks and/or inorganic reinforcing fillers such as silica, with which a coupling agent is typically associated.

Suitable carbon blacks include, for example, HAF, ISAF and SAF types that are conventionally used in tires. Reinforcing carbon blacks of the ASTM grade series 100, 200 and/or 300 are suitable for use, examples of which include the N115, N134, N234, N330, N339, N347, N375 carbon blacks or alternatively, depending on the intended application, carbon blacks of higher ASTM grade series such as N660, N683 and N772.

Inorganic reinforcing fillers include any inorganic or mineral fillers, whatever its color or origin (natural or synthetic), that are capable without any other means, other than an intermediate coupling agent, of reinforcing a rubber composition intended for the manufacture of tires. Such inorganic reinforcing fillers can replace conventional tire-grade carbon blacks, in whole or in part, in a rubber composition intended for the manufacture of tires. Typically such fillers may be characterized as having the presence of hydroxyl (—OH) groups on its surface.

Inorganic reinforcing fillers may take many useful forms including, for example, as powder, microbeads, granules, balls and/or any other suitable form as well as mixtures thereof. Examples of suitable inorganic reinforcing fillers include mineral fillers of the siliceous type, such as silica (SiO₂), of the aluminous type, such as alumina (AlO₃) or combinations thereof.

Useful silica reinforcing fillers known in the art include fumed, precipitated and/or highly dispersible silica (known as “HD” silica). Examples of highly dispersible silicas include Ultrasil 7000 and Ultrasil 7005 from Degussa, the silicas Zeosil 1165MP, 1135MP and 1115MP from Rhodia, the silica Hi-Sil EZ150G from PPG and the silicas Zeopol 8715, 8745 and 8755 from Huber. In particular embodiments, the silica may have a BET surface area, for example, of between 60 m²/g and 250 m²/g or alternatively between 80 m²/g and 230 m²/g.

Examples of useful reinforcing aluminas are the aluminas Baikalox A125 or CR125 from Baikowski, APA-100RDX from Condea, Aluminoxid C from Degussa or AKP-G015 from Sumitomo Chemicals.

For coupling the inorganic reinforcing filler to the diene elastomer, a coupling agent that is at least bifunctional provides a sufficient chemical and/or physical connection between the inorganic reinforcement filler and the diene elastomer. Examples of such coupling agents include bifunctional organosilanes or polyorganosiloxanes. Such coupling agents and their use are well known in the art. The coupling agent may optionally be grafted beforehand onto the diene elastomer or onto the inorganic reinforcing filler as is known. Otherwise it may be mixed into the rubber composition in its free or non-grafted state. One useful coupling agent is X 50-S, a 50-50 blend by weight of Si69 (the active ingredient) and N330 carbon black, available from Evonik Degussa.

In the rubber compositions according to the invention, the content of coupling agent may range, for example, between 2 phr and 15 phr or alternatively, between 4 phr and 12 phr of the coupling agent. However, it is generally desirable to minimize its use and the amount of coupling agent typically represents between 0.5 and 15 wt. % relative to the total weight of the reinforcing inorganic filler. In the case for example of tire treads for passenger vehicles, the coupling agent may be less than 12 wt. % or even less than 10 wt. % relative to the total weight of reinforcing inorganic filler.

In particular embodiments, the amount of total reinforcing filler (carbon black and/or reinforcing inorganic filler) is between 70 phr and 130 phr or alternatively between 90 phr and 120 phr or between 80 phr and 120 phr. In particular embodiments of the rubber compositions disclosed herein, the total reinforcing filler is silica with no more than 20 phr or alternatively no more than 10 phr of carbon black. In other embodiments, the total reinforcing filler is carbon black or alternatively, any mixture of suitable reinforcing fillers.

In addition to the diene elastomer and reinforcing filler, particular embodiments of the rubber composition disclosed herein may further include a plasticizing system. The plasticizing system may provide both an improvement to the processability of the rubber mix and/or a means for adjusting the rubber composition's hysteresis and/or rigidity. Suitable plasticizing systems may include, for example, a processing oil, a plasticizing resin or combinations thereof.

Suitable processing oils may include those derived from petroleum stocks, those having a vegetable base and combinations thereof. Examples of oils that are petroleum based include aromatic oils, paraffinic oils, naphthenic oils, MES oils, TDAE oils and so forth as known in the industry.

Examples of suitable vegetable oils include sunflower oil, soybean oil, safflower oil, corn oil, linseed oil and cotton seed oil. These oils and other such vegetable oils may be used singularly or in combination. In some embodiments, sunflower oil having a high oleic acid content (at least 70 weight percent or alternatively, at least 80 weight percent) is useful, an example being AGRI-PURE 80, available from Cargill with offices in Minneapolis, Minn.

The amount of plasticizing oil, if any, useful in any particular embodiment of the present invention depends upon the particular circumstances and the desired result. In general, for example, the plasticizing oil, may be present in the rubber composition in an amount of between 15 phr and 60 phr or alternatively, between 20 phr and 55 phr or between 15 phr and 80 phr.

A plasticizing hydrocarbon resin is a hydrocarbon compound that is solid at ambient temperature (e.g., 23° C.) as opposed to a liquid plasticizing compound, such as a plasticizing oil. Additionally a plasticizing hydrocarbon resin is compatible, i.e., miscible, with the rubber composition with which the resin is mixed at a concentration that allows the resin to act as a true plasticizing agent, e.g., at a concentration that is typically at least 5 phr (parts per hundred parts rubber by weight) or even much higher.

Plasticizing hydrocarbon resins are polymers that can be aliphatic, aromatic or combinations of these types, meaning that the polymeric base of the resin may be formed from aliphatic and/or aromatic monomers. These resins can be natural or synthetic materials and can be petroleum based, in which case the resins may be called petroleum plasticizing resins, or based on plant materials. In particular embodiments, although not limiting the invention, these resins may contain essentially only hydrogen and carbon atoms.

The plasticizing hydrocarbon resins useful in particular embodiment of the present invention include those that are homopolymers or copolymers of cyclopentadiene (CPD) or dicyclopentadiene (DCPD), homopolymers or copolymers of terpene, homopolymers or copolymers of C₅ cut and mixtures thereof.

Such copolymer plasticizing hydrocarbon resins as discussed generally above may include, for example, resins made up of copolymers of (D)CPD/vinyl-aromatic, of (D)CPD/terpene, of (D)CPD/C₅ cut, of terpene/vinyl-aromatic, of C₅ cut/vinyl-aromatic and of combinations thereof.

Terpene monomers useful for the terpene homopolymer and copolymer resins include alpha-pinene, beta-pinene and limonene. Particular embodiments include polymers of the limonene monomers that include three isomers: the L-limonene (levorotatory enantiomer), the D-limonene (dextrorotatory enantiomer), or even the dipentene, a racemic mixture of the dextrorotatory and laevorotatory enantiomers.

Examples of vinyl aromatic monomers include styrene, alpha-methylstyrene, ortho-, meta-, para-methylstyrene, vinyl-toluene, para-tertiobutylstyrene, methoxystyrenes, chloro-styrenes, vinyl-mesitylene, divinylbenzene, vinylnaphthalene, any vinyl-aromatic monomer coming from the C₉ cut (or, more generally, from a C₈ to C₁₀ cut). Particular embodiments that include a vinyl-aromatic copolymer include the vinyl-aromatic in the minority monomer, expressed in molar fraction, in the copolymer.

Particular embodiments of the present invention include as the plasticizing hydrocarbon resin the (D)CPD homopolymer resins, the (D)CPD/styrene copolymer resins, the polylimonene resins, the limonene/styrene copolymer resins, the limonene/D(CPD) copolymer resins, C₅ cut/styrene copolymer resins, C₅ cut/C₉ cut copolymer resins, and mixtures thereof.

Commercially available plasticizing resins that include terpene resins suitable for use in the present invention include a polyalphapinene resin marketed under the name Resin R2495 by Hercules Inc. of Wilmington, Del. Resin R2495 has a molecular weight of about 932, a softening point of about 135° C. and a glass transition temperature of about 91° C. Another commercially available product that may be used in the present invention includes DERCOLYTE L120 sold by the company DRT of France. DERCOLYTE L120 polyterpene-limonene resin has a number average molecular weight of about 625, a weight average molecular weight of about 1010, an Ip of about 1.6, a softening point of about 119° C. and has a glass transition temperature of about 72° C. Still another commercially available terpene resin that may be used in the present invention includes SYLVARES TR 7125 and/or SYLVARES TR 5147 polylimonene resin sold by the Arizona Chemical Company of Jacksonville, Fla. SYLVARES 7125 polylimonene resin has a molecular weight of about 1090, has a softening point of about 125° C., and has a glass transition temperature of about 73° C. while the SYLVARES TR 5147 has a molecular weight of about 945, a softening point of about 120° C. and has a glass transition temperature of about 71° C.

Other suitable plasticizing hydrocarbon resins that are commercially available include C₅ cut/vinyl-aromatic styrene copolymer, notably C₅ cut/styrene or C₅ cut/C₉ cut from Neville Chemical Company under the names SUPER NEVTAC 78, SUPER NEVTAC 85 and SUPER NEVTAC 99; from Goodyear Chemicals under the name WINGTACK EXTRA; from Kolon under names HIKOREZ T1095 and HIKOREZ T1100; and from Exxon under names ESCOREZ 2101 and ECR 373.

Yet other suitable plasticizing hydrocarbon resins that are limonene/styrene copolymer resins that are commercially available include DERCOLYTE TS 105 from DRT of France; and from Arizona Chemical Company under the name ZT115LT and ZT5100.

It may be noted that the glass transition temperatures of plasticizing resins may be measured by Differential Scanning calorimetry (DCS) in accordance with ASTM D3418 (1999). In particular embodiments, useful resins may be have a glass transition temperature that is at least 25° C. or alternatively, at least 40° C. or at least 60° C. or between 25° C. and 95° C., between 40° C. and 85° C. or between 60° C. and 80° C.

The amount of plasticizing hydrocarbon resin useful in any particular embodiment of the present invention depends upon the particular circumstances and the desired result. In general, for example, the plasticizing hydrocarbon resin, if any, may be present in the rubber composition in an amount of between 5 phr and 50 phr or alternatively, between 10 phr and 40 phr, between 10 phr and 30 phr, between 5 phr and 25 phr, between 1 phr and 14 phr or less than 15 phr.

The rubber compositions disclosed herein may be cured with any suitable curing system including a peroxide curing system or a sulfur curing system. Particular embodiments are cured with a sulfur curing system that includes free sulfur and may further include, for example, one or more of accelerators, stearic acid and zinc oxide. Suitable free sulfur includes, for example, pulverized sulfur, rubber maker's sulfur, commercial sulfur, and insoluble sulfur. The amount of free sulfur included in the rubber composition is not limited and may range, for example, between 0.2 phr and 10 phr or alternatively between 0.5 phr and 5 phr or between 0.5 phr and 3 phr. Particular embodiments may include no free sulfur added in the curing system but instead include sulfur donors.

Accelerators are used to control the time and/or temperature required for vulcanization and to improve the properties of the cured rubber composition. Particular embodiments of the present invention include one or more accelerators. One example of a suitable primary accelerator useful in the present invention is a sulfenamide. Examples of suitable sulfenamide accelerators include n-cyclohexyl-2-benzothiazole sulfenamide (CBS), N-tert-butyl-2-benzothiazole Sulfenamide (TBBS), N-Oxydiethyl-2-benzthiazolsulfenamid (MBS) and N′-dicyclohexyl-2-benzothiazolesulfenamide (DCBS). Combinations of accelerators are often useful to improve the properties of the cured rubber composition and the particular embodiments include the addition of secondary accelerators.

Particular embodiments may include as a secondary accelerant the use of a moderately fast accelerator such as, for example, diphenylguanidine (DPG), triphenyl guanidine (TPG), diorthotolyl guanidine (DOTG), o-tolylbigaunide (OTBG) or hexamethylene tetramine (HMTA). Such accelerators may be added in an amount of up to 4 phr, between 0.5 and 3 phr, between 0.5 and 2.5 phr or between 1 and 2 phr. Particular embodiments may exclude the use of fast accelerators and/or ultra-fast accelerators such as, for example, the fast accelerators: disulfides and benzothiazoles; and the ultra-accelerators: thiurams, xanthates, dithiocarbamates and dithiophosphates.

Other additives can be added to the rubber compositions disclosed herein as known in the art. Such additives may include, for example, some or all of the following: antidegradants, antioxidants, fatty acids, waxes, stearic acid and zinc oxide. Examples of antidegradants and antioxidants include 6PPD, 77PD, IPPD and TMQ and may be added to rubber compositions in an amount, for example, of from 0.5 phr and 5 phr. Zinc oxide may be added in an amount, for example, of between 1 phr and 6 phr or alternatively, of between 1.5 phr and 4 phr. Waxes may be added in an amount, for example, of between 1 phr and 5 phr.

The rubber compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C., more narrowly between 130° C. and 170° C., is reached.

After cooling of the mixture, a second phase of mechanical working is implemented at a lower temperature. Sometimes referred to as “productive” phase, this finishing phase consists of incorporating by mixing the vulcanization (or cross-linking) system (sulfur or other vulcanizing agent and accelerator(s)), in a suitable device, for example an open mill. It is performed for an appropriate time (typically between 1 and 30 minutes, for example between 2 and 10 minutes) and at a sufficiently low temperature lower than the vulcanization temperature of the mixture, so as to protect against premature vulcanization.

The rubber composition can be formed into useful articles, including treads for use on vehicle tires. The treads may be formed as tread bands and then later made a part of a tire or they be formed directly onto a tire carcass by, for example, extrusion and then cured in a mold. As such, tread bands may be cured before being disposed on a tire carcass or they may be cured after being disposed on the tire carcass. Typically a tire tread is cured in a known manner in a mold that molds the tread elements into the tread, including, e.g., tread blocks, tread ribs and/or the sipes molded into the tread blocks and/or the tread ribs.

It is recognized that treads may be formed from only one rubber composition or in two or more layers of differing rubber compositions, e.g., a cap and base construction. In a cap and base construction, the cap portion of the tread is made of one rubber composition that is designed for contact with the road. The cap is supported on the base portion of the tread, the base portion made of a different rubber composition. In particular embodiments of the present invention the entire tread may be made from the rubber compositions as disclosed herein while in other embodiments only the cap portions of the tread may be made at least in part from such rubber compositions. In particular embodiments of the treads disclosed herein, the cap portion is entirely manufactured of the rubber composition having the high- and low-Tg rubber components as disclosed herein.

While these tire treads are suitable for many types of vehicles, particular embodiments include tire treads for use on vehicles such as passenger cars and/or light trucks. Such tire treads are also useful for all weather tires and/or snow tires.

The invention is further illustrated by the following examples, which are to be regarded only as illustrations and not delimitative of the invention in any way. The properties of the compositions disclosed in the examples were evaluated as described below and these utilized methods are suitable for measurement of the claimed properties of the invention and the described properties of the disclosed embodiments.

The maximum tan delta dynamic properties for the rubber compositions were measured at 23° C. on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress at a frequency of 10 Hz under a controlled temperature of 23° C. Scanning was effected at an amplitude of deformation of 0.05 to 50% (outward cycle) and then of 50% to 0.05% (return cycle). The maximum value of the tangent of the loss angle tan delta (max tan 6) was determined during the return cycle.

Dynamic properties (Tg and G*) for the rubber compositions were measured on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress of a constant 0.7 MPa and at a frequency of 10 Hz over a temperature sweep from −60° C. to 100° C. with the temperature increasing at a rate of 1.5° C./min. The shear modulus G* at 60° C. was captured and the temperature at which the max tan delta occurred was recorded as the glass transition temperature, Tg.

Snow grip (%) on snow-covered ground was evaluated by measuring the forces on a single driven test tire in snow according to the ASTM F1805 test method. The vehicle travels at a constant 5 mph speed and the forces are measured on the single test tire at the target slip. A value greater than that of the Standard Reference Test Tire (SRTT), which is arbitrarily set to 100, indicates an improved result, i.e., improved grip on snow.

### Example 1

Rubber compositions were prepared using the components shown in Table 1. The amount of each component making up the rubber compositions are provided in parts per hundred parts of rubber by weight (phr). The glass transition temperatures of the rubber components are also provided in Table 1.

The carbon black (CB) was N234. The silica was ZEOSIL 160, a highly dispersible silica available from Rhodia having a BET of 160 m²/g. The plasticizing oil was sunflower oil, AGRI-PURE 80 from Cargill. The resin was a C5-C9 hydrocarbon resin OPPERA 373, having a Mn of about 900 g/mole, a MW of about 1750 g/mole, a Tg of about 42° C., available from ExxonMobil. The silane coupling agent was X 50-S available from Evonik Degussa. The curative package included sulfur, accelerators, zinc oxide and stearic acid while the additive package included paraffin and 6PPD.

The rubber formulations were prepared by mixing the components given in Table 1, except for the accelerators and sulfur, in a Banbury mixer until the materials were well distributed and a temperature of the mixture was between 130° C. and 170° C. The accelerators and sulfur were added in a second phase on a mill. The rubber composition was cured at 150° C. for 40 minutes and was then tested for physical properties, the results of which are shown in Table 1.

TABLE 1
Rubber Formulations, Physical Properties

| | Formulations | | |
|---|---|---|---|
| | W1 | W2 | F1 |
| SBR, Tg −88° C. | 100 | 70 | 70 |
| SBR, Tg −12° C. | | | 30 |
| SBR, Tg −65° C. | | 30 | |
| CB | 8.6 | 8.6 | 8.6 |
| Silica | 107 | 107 | 107 |
| Oil | 3.5 | 9.6 | 48.5 |
| Resin | 77 | 67 | 14 |
| Silane Coupling Agent | 8.6 | 8.6 | 8.6 |
| Additives | 3.4 | 3.4 | 3.4 |
| Curing Package | 8.1 | 8.1 | 8.1 |
| Physical Properties | | | |
| Tg, ° C. | −25.6 | −26.7 | −21.2 |
| Modulus G* at −20° C. | 7.21 | 6.07 | 8.02 |
| Modulus G* at 60° C. | 0.78 | 0.73 | 0.77 |
| Max Tan Delta at 23° C. | 0.28 | 0.30 | 0.26 |

The witness formulation W1 included only a low Tg SBR and the second witness formulation W2 included a blend of compatible rubbers. However, the formulation F1, an embodiment of the present invention, included two incompatible rubber components, one with a Tg of −88° C. and the other with a Tg of −12° C. As can be seen from the testing results, the witnesses W1 and W2 both resulted in providing a rubber composition with a lower Tg and a lower modulus at −20° C. than the embodiment F1.

### Example 2

The rubber compositions described in Example 1 were used to manufacture sets of tires (205 55R 16) for testing. The tires were tested in accordance with the ASTM F1805 snow grip test method and the results were normalized against the witness rubber composition W1. With the normalized snow traction being 100% for the tire having the tire tread manufactured from the W1 composition, the normalized snow traction for the tire having the tread manufactured from second witness composition with the compatible rubber blend was 99% and the F1 composition was 115%.

The significantly improved snow traction achieved with the tread manufactured from the two incompatible rubber components is particularly surprising because the Tg of the witness rubber compositions W1 and W2 were lower than the Tg of the rubber composition F1, indicating that the witness compositions should have provided the better snow traction. Likewise, with the G* at −20° C. of the witness rubber compositions being lower than the G* at −20° C. of the incompatible blend rubber composition F1, it was surprising that the snow traction of the F1 tread was better than that of both the witness treads much less that it was improved by 15%.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

What is claimed is:

1. A tread for a tire, the tread comprising a rubber composition that is based upon a cross-linkable elastomer composition, the cross-linkable elastomer composition comprising, per hundred parts by weight of rubber (phr):
a high-Tg rubber being a highly unsaturated diene elastomer having a glass transition temperature of between −30° C. and 0° C.;
a low-Tg rubber being a highly unsaturated diene elastomer having a glass transition temperature of between −110° C. and −60° C., wherein the high-Tg and the low-Tg elastomers are incompatible;
a reinforcing filler; and
a curing system.

2. The tread of claim 1, wherein the high-Tg rubber is selected from a synthetic polyisoprene rubber, an isoprene/styrene copolymer, a styrene/butadiene copolymer and combinations thereof.

3. The tread of claim 1, wherein the low-Tg rubber is selected from a polybutadiene, synthetic isoprene rubber, an isoprene/styrene copolymer, a styrene/butadiene copolymer, a natural rubber and combinations thereof.

4. The tread of claim 1, wherein the elastomer composition comprises between 55 phr and 90 phr of the low-Tg rubber.

5. The tread of claim 1, wherein the elastomer composition comprises between 10 phr and 45 phr of the high-Tg rubber.

6. The tread of claim 1, wherein the elastomer composition comprises between 70 phr and 130 phr of the reinforcing filler.

7. The tread of claim 6, wherein the reinforcing filler is silica and no more than 20 phr of carbon black.

8. The tread of claim 1, wherein the elastomer composition comprises between 80 phr and 120 phr of the reinforcing filler.

9. The tread of claim 1, wherein the reinforcing filler comprises carbon black, silica and combinations thereof.

10. The tread of claim 1, wherein the high-Tg and the low-Tg rubbers are both a styrene/butadiene copolymer.

11. The tread of claim 1, wherein the high-Tg rubber is a styrene/butadiene copolymer and the low-Tg rubber is a natural rubber.

12. The tread of claim 1, wherein the high-Tg rubber is a styrene/butadiene copolymer and the low-Tg rubber is a polybutadiene rubber.

13. The tread of claim 1, wherein the elastomer composition further comprises a plasticizing system that is selected from an oil, a plasticizing resin or combinations thereof.

14. The tread of claim 13, wherein the plasticizing system is the oil.

15. The tread of claim 13, wherein the plasticizing system comprises less than 15 phr of the resin.

16. The tread of claim 13, wherein the plasticizing system comprises between 5 phr and 50 phr of the resin.
